(19) United States
(12) Patent Application Publication
(10) Pub. No.: US 2019/0028750 A1
(43) Pub. Date: Jan. 24, 2019

(54) MEDIA ASSET RECOMMENDATIONS AND SORTING BASED ON RENDERING DEVICE PROPERTIES

(71) Applicant: THOMSON LICENSING, Issy-les-Moulineaux (FR)

(72) Inventor: Thomas WALSH, Somerset, NJ (US)

(73) Assignee: THOMSON Licensing, Issy les Moulineaux (FR)

(21) Appl. No.: 16/071,497

(22) PCT Filed: Jan. 21, 2016
(86) PCT No.: PCT/US2016/014257

§ 371 Date: Jul. 20, 2018

(51) Int. Cl. H04N 21/258; H04N 21/466; H04N 21/475

(52) U.S. Cl. CPC H04N 21/25833; H04N 21/4756; H04N 21/4668; H04N 21/25891

(57) ABSTRACT

A method and an apparatus for operating a set top box are described including determining if the set top box can detect components and properties of a rendering device, detecting the components and the properties of the rendering device, prompting a user to enter a list of the components and the properties of the rendering device if the set top box cannot detect the components and the properties of the rendering device, accepting the list of the components and the properties of the rendering device from the user, compiling a system configuration file, performing a look-up of scores for the components and the properties of the rendering device, expanding the system configuration file using the scores of the look-up operation, calculating an aggregate score and entering the aggregate score into the expanded system configuration file and storing the expanded system configuration file.

### FIELD

The proposed method and apparatus relate to media asset recommendation and, in particular to proving the recommendation engine of the streaming service information regarding the properties of the rendering device.

### BACKGROUND

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Today there are many television (TV) display formats. Television display formats can run from extremely small displays with a tiny speaker in mobile devices like cell phones to very large displays and 7.1 sound systems or greater in high end televisions like 8K. Typically, when someone buys an expensive TV with new and unique properties, they want to watch content that caters to those properties. This desire brings with it the need for recommendation categories based on the hardware available in the rendering device.

Example Categories:

Sound: Stereo, 3.1, 5.1, 7.1, Dolby 5.1; THX

Display: SD; HD; UHD 4k; FUHD 8k; 3D

Accessories: ambient backlight

### SUMMARY

A method and an apparatus for operating a set top box are described including determining if the set top box can detect components and properties of a rendering device, detecting the components and the properties of the rendering device, prompting a user to enter a list of the components and the properties of the rendering device if the set top box cannot detect the components and the properties of the rendering device, accepting the list of the components and the properties of the rendering device from the user, compiling a system configuration file, performing a look-up of scores for the components and the properties of the rendering device, expanding the system configuration file using the scores of the look-up operation, calculating an aggregate score and entering the aggregate score into the system configuration file and storing the expanded system configuration file. Also described are a method and an apparatus for operation of a streaming media service including determining if a streaming media service has a user profile of user preferences available, retrieving the user profile if the user profile is available, determining if the streaming media service has an expanded system configuration file of components and properties of a rendering device available, retrieving the expanded system configuration file if the expanded system configuration file is available, identifying media assets that may be of interest to a user based on the user profile and the expanded system configuration file, retrieving media metadata of multiple versions of the identified media assets, selecting a particular version of a media asset from among said identified media assets using said media metadata to recommend to the user and forwarding an indication of the selected particular version of the media asset to a set top box for the user.

### BRIEF DESCRIPTION OF THE DRAWINGS

The proposed method and apparatus is best understood from the following detailed description when read in conjunction with the accompanying drawings. The drawings include the following figures briefly described below:

FIG. 1 is a schematic diagram of an exemplary system in which the proposed method and apparatus operate.

FIG. 2 is a flowchart of an exemplary implementation of the method for operation of a set top box.

FIG. 3 is a flowchart of exemplary implementation of the method for operation of a streaming media service.

FIG. 4 is a block diagram of an exemplary set top box.

FIG. 5 is a block diagram of an exemplary streaming media service.

It should be understood that the drawings) are for purposes of illustrating the concepts of the disclosure and is not necessarily the only possible configuration for illustrating the disclosure.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

To facilitate recommendation categories based on the hardware available in the rendering device within a streaming environment, the streaming client or set top box (STB) will need to detect or accept manual entry of the connected components. Example components include sound (e.g., Stereo, 3.1, 5.1, 7.1, Dolby 5.1; American high-fidelity audio/visual reproduction standard named after Tomlinson Holman (THX)), display (e.g., standard definition TV (SD); high definition TV (HD); ultra-high definition TV (UHD) 4k; full ultra-high definition TV (FUHD), 8k; three-dimensional TV (3D)) and accessories (ambient backlight). Some of these devices such as the display itself may be detected through the HDMI cable, through the presence of connectors in jacks, or through other methods.

After the component list is detected or manually entered, the component list is compiled into a system configuration file. The system configuration file is then expanded by the STB/client performing a lookup (web or local) to retrieve specific scores for the manually entered or detected components. Once the individual scores are retrieved, the scores are associated with their components in the system configuration file, then the scores are combined into an aggregate score, which is also entered into the system configuration file.

It is noted that detecting a system's configuration is known to occur in the computer domain. This data is typically used either to ensure proper drivers or check that the machine is the one the software is supposed to be running on.

Some components will be of higher quality than others. In display technologies, comparing displays of the same type a user may see variances in color gamut, higher dynamic range, frame rate, size, resolution to name a few. These additional features can either be summarized in the device specific score or can be considered separately as extra fields within the system configuration file. The system configuration file can take on many forms but for the sake of discussion the data is encapsulated into an XML File.

It is known that there are methods to “map” a higher quality signal onto a lower quality device as well as reverse techniques. However, these mappings result in a lower quality presentation. The score looks to most closely match the rendering devices to the original or unmodified form of the multimedia asset to ensure the greatest quality presentation.

Example Mappings include, for example:
A Dolby 5.1 sound data is mapped to stereo output. In mapping this data sound quality is lost. Conversely, stereo can be mapped onto Dolby 5.1 but the sound quality will not be improved.
If a wide color gamut is mapped onto a smaller color gamut then some colors are lost. Conversely, if a small color gamut is mapped onto a wide color gamut, there will not be any color quality improvement because the colors that were not available in the small color gamut are still unavailable.

When the user attempts to browse movies on a streaming service such as M-Go or Netflix, the client/STB transmits (sends, forwards) the system configuration file to the recommendation engine of the streaming service. The recommendation engine uses the user profile/history data and the system configuration file to determine (locate, find) recommendations of media assets similar to those media assets the user has already viewed and of higher value (quality) to the user based on the user's entertainment system.

When selecting media assets that cost money, dialogs and parental controls are optionally utilized to help manage costs. An example parental control allows the parent to choose what, if any, device attributes the Recommendation Engine can use in selecting recommendations for the child. So, if the system has an 8K Display the parent has the ability to submit an alternate option like Standard Definition or to eliminate or lock out 8K media assets from being selected by the child. This way the child will not accidentally incur excessive charges. Prior to starting a high cost media asset the viewer can have the option to view a list of the alternate (less expensive) versions of the media asset.

The recommendation engine creates component specific categories based on both the system configuration file and media asset metadata. It should be noted that different versions of the media asset will have different metadata depending on the quality associated with the media asset (e.g., Dolby, UHD, etc.). Further the recommendation engine uses the aggregate score to sort the media asset recommendations. Each media asset file will have an aggregate score associated with it based on the properties of the media asset file. One method of sorting the categories involves taking the absolute value of subtracting the system configuration file's aggregate score from the media's aggregate score. The resulting values will then present a Euclidian distance from the target device. Lower numbers will be closer to the target device (highest quality), and higher numbers will be further (poorer quality) from the target device. This Euclidian distance metric can then be used to sort the categories, placing the media that most closely matches the target system (device) at the top (start) of the category.

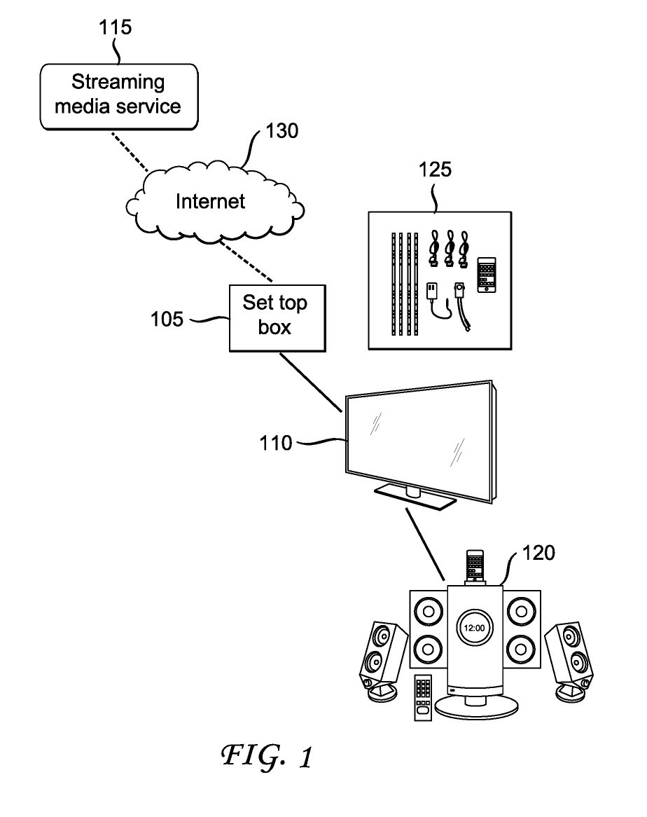

FIG. 1 is a schematic diagram of an exemplary system in which the proposed method and apparatus operate. Included in FIG. 1 is a set top box (STB) 105, which is the center of the present proposed method and apparatus. The STB is connected (wired line or wirelessly) to a TV 110. The TV may be connected to a home entertainment system 120 and/or additional accessories 125. These connections may also be wired line or wireless. The STB is also connected to a streaming media service 115 through the internet (cloud) 130. The connections between the STB and the internet and between the internet and the streaming media service are shown with dotted lines to indicate that these connections are wireless. Any connections that are wireless means that the devices operating in such a fashion (manner) include some form of antenna for reception and transmission of wireless signals.

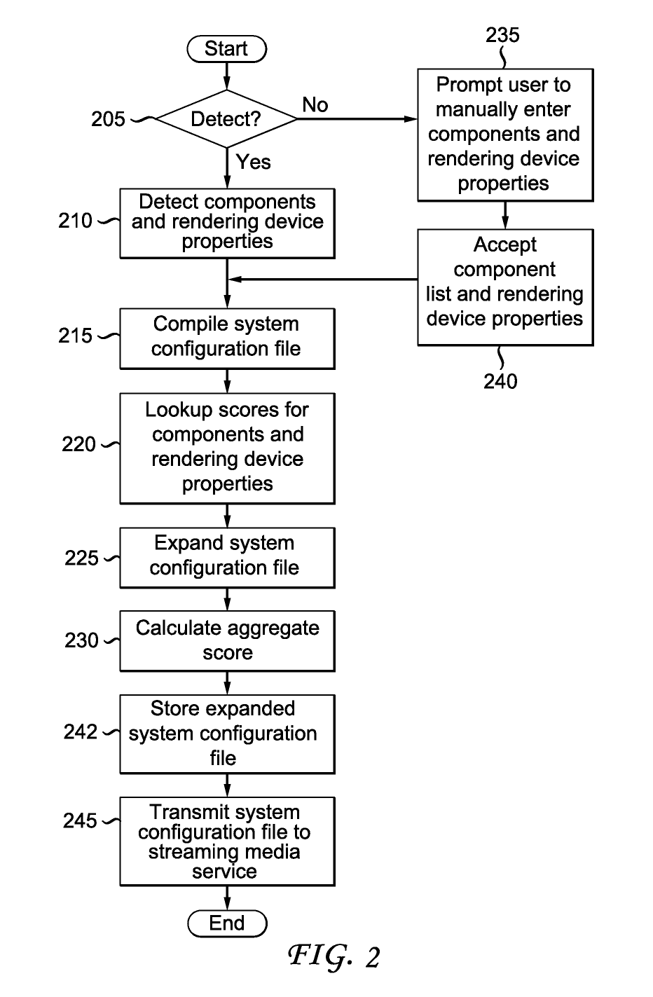

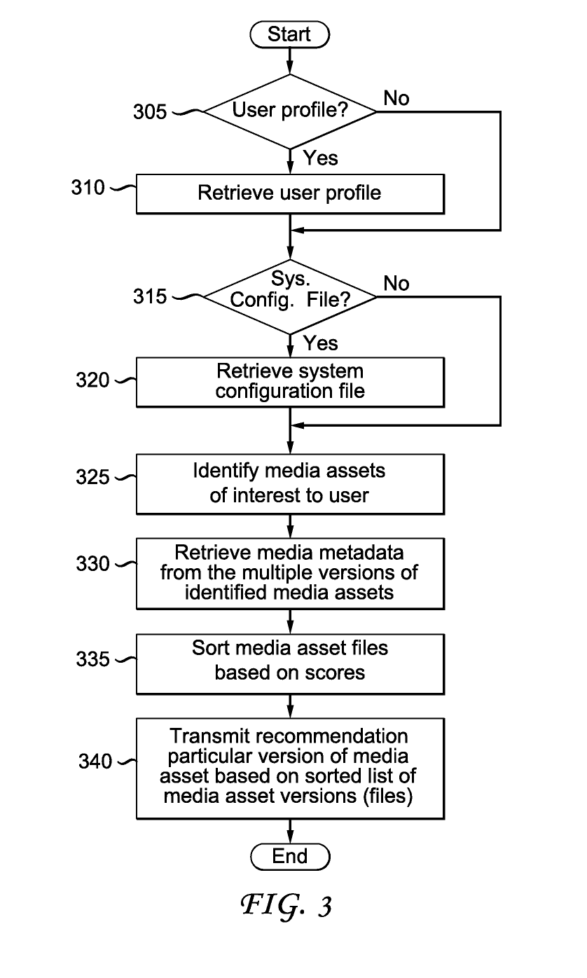

FIG. 2 is a flowchart of an exemplary implementation of the method for operation of a set top box. At 205 a test is performed to determine if the set top box can detect the components and rendering device properties. If the set top box is able to detect the components and rendering device properties then at 210 the components and rendering device properties are detected. At 215 the set top box compiles a system configuration file. At 220 the set top box performs a look-up of scores for the components and rendering device properties. At 225 the set top box expands the system configuration file using the scores of the look-up operation. The looked-up scores are associated with the components and rendering device properties in the system configuration file. At 230 the set top box calculates an aggregate score and enters the aggregate score into the system configuration file. At 242 the expanded system configuration file including the aggregate score is stored (recorded, logged) in memory (storage) for future use. At 245 the expanded system configuration file is transmitted to the streaming media service when requested. If the set top box is not able to detect the components and rendering device properties then at 235 the user is prompted to enter the components and rendering device properties by the set top box. At 240 the set top box accepts the list of components and rendering device properties. Prior to 205, the set top box may check to see if it has a saved expanded system configuration file. If the set top box has a saved expanded system configuration file, then a test is performed to determine if the saved expanded system configuration file is consistent with the attached devices. If the saved expanded system configuration file is consistent with the components and rendering device properties then the saved expanded system configuration file is loaded and processing skips to 245. If the saved expanded system configuration file is not consistent with the components and rendering device properties then processing proceeds to 205. The expanded system configuration file may be saved for future use prior to transmitting the expanded system configuration file to the streaming media service. FIG. 3 is a flowchart of exemplary implementation of the method for operation of a streaming media service. At 305 the recommendation engine of the streaming media service performs a test to determine if the streaming media service recommendation engine has a user profile (history) of user preferences. If a user profile is available then at 310 the user profile (history) is retrieved. At 315 the recommendation engine of the streaming media service performs a test to determine if the streaming media service recommendation engine has a system configuration file. If a user profile is not available, then processing proceeds to 315. If a system configuration file is available then at 320 the system configuration file is retrieved. At 325 the recommendation engine of the streaming media service identifies media assets that may be of interest to the user based on the user profile and the system configuration file. If a system configuration file is not available, then processing proceeds to 325. At 330 the recommendation engine of the streaming media service retrieves media metadata from the multiple versions of identified media assets that may be of interest to the user. Media metadata includes scores based on properties of the media asset file associated with the media metadata. At 335 the recommendation engine of the streaming media service sorts the media asset files based on the scores. At 340 the recommendation engine of the streaming media service selects a particular version of a particular media asset to recommend to the user and forwards (transmits) that recommendation to the user through the set top box.

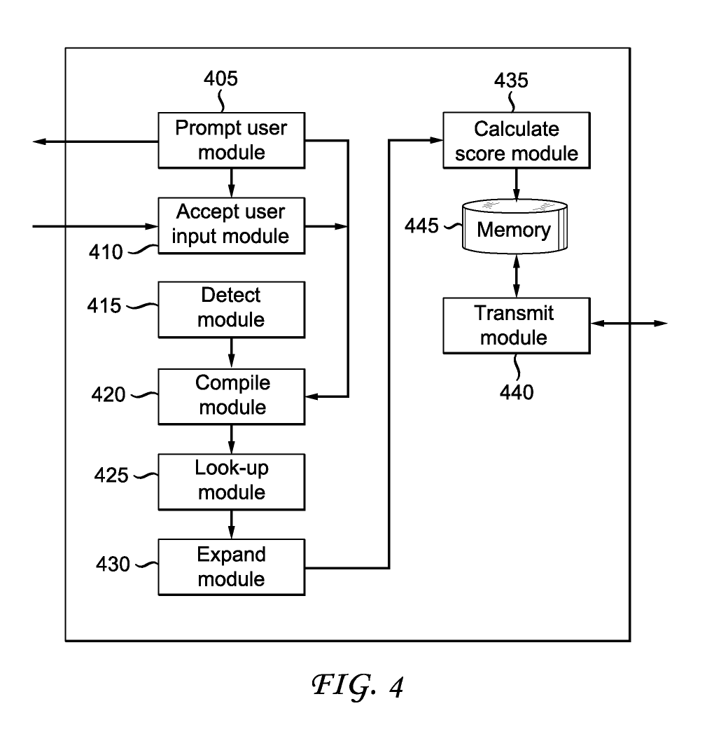

FIG. 4 is a block diagram of an exemplary set top box. For simplicity a communications interface, which is or may be used to interface with a user or media service provider, is not shown. A communications interface is well known in the art for such purposes. The detect module 415 detects components and properties of a rendering device. If the detect module is unable to detect the components and the properties of the rendering device then the prompt user module 405 prompts the user to manually enter information about the components and the properties of the rendering device through the accept user input module 410. The components and properties of the rendering device are used by the compile module 420 to compile a system configuration file. The look-up module 425 looks-up scores for the components and the properties of the rendering device. The expand module 430 expands the system configuration file using the scores from the look-up module. The calculate module 435 calculates an aggregate score and puts the aggregate score into the expanded system configuration file. The expanded system configuration file including the aggregate score is stored (recorded, logged) in memory (storage) 445 for future use. The transmit module 440 transmits the expanded system configuration file to a streaming media service when requested. When the user goes to browse a content media services' offerings, the expanded system configuration file is transmitted. The expanded system configuration file is transmitted either with the request for content media service offerings or the content media service specifically requests the expanded system configuration file after receiving a request for service offerings. The media service provider request may be accepted by a communications interface (not shown) and forwarded to the transit module, which access memory to retrieve the expanded system configuration file and forward the expanded system configuration file to the media service provider.

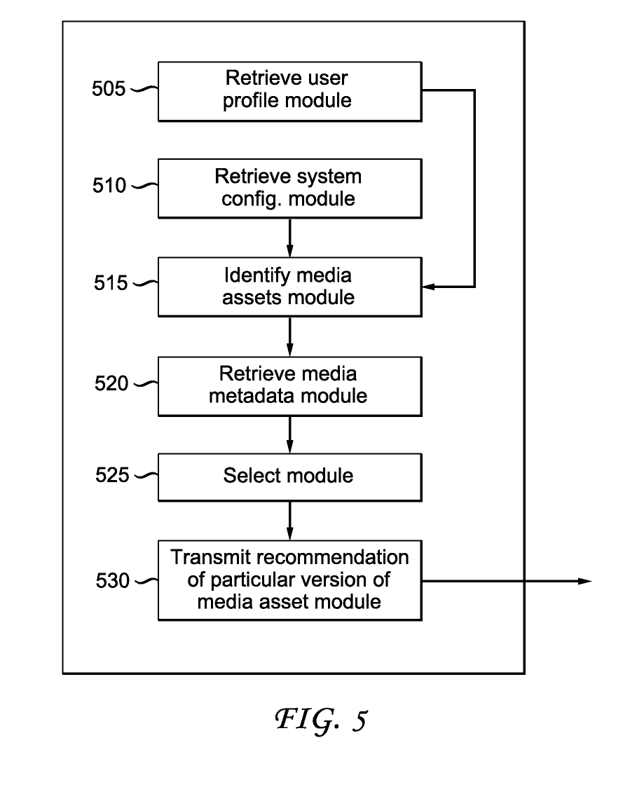

FIG. 5 is a block diagram of an exemplary streaming media service. The retrieve user profile module 505 retrieves the user profile (history) if the user profile (history) is available. The retrieve system configuration module 510 retrieves the expanded system configuration file that was transmitted (if the expanded system configuration file was transmitted to the streaming media service by the set top box) to the recommendation engine of the streaming media service by the set top box. The identify media assets module 515 identifies media assets that may be of interest to the user. The identify media assets module uses both the expanded system configuration file and the user profile (if available). The retrieve media metadata module 520 retrieves media metadata from the multiple versions of identified media assets that may be of interest to the user. Media metadata includes scores based on properties of the media assets associated with the media metadata. The select module 525 of the recommendation engine of the streaming media service sorts the media assets based on the scores. The select module also retrieves aggregate scores from each media asset of the identified media assets. The select module then calculates a difference between each aggregate score of each media asset of the identified media assets and an aggregate score in the expanded system configuration file and takes the absolute value of the difference. The select module then sorts the media assets responsive to said absolute value of the difference. The aggregate score of each media asset is based on properties of the media assets. The recommend particular version of the media asset module (the recommend module) 530 of the recommendation engine of the streaming media service selects a particular version of a particular media asset to recommend to the user and forwards that recommendation to the user through the set top box. The recommend particular version of media asset module also offers the user less expensive alternatives to the selected particular media asset, accepts the user's selection of the particular version of the media asset and forwards the user's selection of the particular media asset to the set top box for the user.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus are programmed. Given the teachings herein, one of ordinary skill in the related art will be able to contemplate these and similar implementations or configurations of the proposed method and apparatus.

1. A method for operating a set top box, said method comprising:
determining if said set top box can detect components and properties of a rendering device;
detecting said components and said properties of said rendering device;
prompting a user to enter a list of said components and said properties of said rendering device if said set top box cannot detect said components and said properties of said rendering device;
accepting said list of said components and said properties of said rendering device from said user;
compiling a system configuration file;
performing a look-up of scores for said components and said properties of said rendering device;
expanding said system configuration file using said scores of said look-up operation;
calculating an aggregate score and entering said aggregate score into the system configuration file; and
storing said expanded system configuration file.

2. The method according to claim 1, further comprising transmitting said expanded system configuration file to a media service provider upon request, wherein said transmission is wireless.

3. The method according to claim 1, further comprising storing said expanded system configuration file.

4. A method for operation of a streaming media service, said method comprising:
determining if a recommendation engine of said streaming media service has a user profile of user preferences available;
retrieving said user profile if said user profile is available;
determining if said streaming media service has an expanded system configuration file of components and properties of a rendering device available;
retrieving said expanded system configuration file, if said expanded system configuration file is available;
identifying media assets that may be of interest to a user based on said user profile and said expanded configuration file;
retrieving media metadata of multiple versions of said 5 identified media assets;
selecting a particular version of a particular identified media asset from among the identified media assets using said media metadata to recommend to said user; and
forwarding an indication of said selected particular version of said particular media asset to a set top box for said user.

5. The method according to claim 4, wherein said selecting further comprises:
retrieving aggregate scores of each media asset of said identified media assets;
calculating a difference between each aggregate score of each media asset of said identified media assets and an aggregate score in said expanded system configuration file;
calculating an absolute value of said difference; and
sorting said media assets responsive to said absolute value of said difference.

6. The method according to claim 5, wherein said aggregate scores of each media asset are based on properties of said media asset.

7. The method according to claim 4, further comprising:
offering said user less expensive alternatives to said selected particular media asset if said selected particular media asset appears to be for a child;
accepting said user's selection of said particular media asset; and
forwarding said user's selection of said particular media asset to said set top box for said user.

8. The method according to claim 7, wherein said forwarding is wireless.

9. A set top box, comprising:
a detect module, said detect module determining if said set top box can detect components and properties of a rendering device;
said detect module detecting said components and said properties of said rendering device;
a prompt user module, said prompt user module prompting a user to enter a list of said components and said properties of said rendering device if said set top box cannot detect said components and said properties of said rendering device;
an accept user input module, said accept user input module accepting said list of said components and said properties of said rendering device from said user;
a compile module, said compile module compiling a system configuration file, said compile module in communication with said detect module, said compile module also in communication with said accept user input module, said compile module also in communication with said prompt user module;
a look-up module, said look-up module performing a look-up of scores for said components and said properties of said rendering device, said look-up module in communication with said compile module;
an expand module, said expand module expanding said system configuration file using said scores of said look-up operation, said expand module in communication with said look-up module;
a calculate score module, said calculate score module calculating an aggregate score and entering said aggregate score into the expanded system configuration file, said calculate score module in communication with said expand module; and
said calculate score module storing said expanded configuration file in a memory.

10. The set top box according to claim 9, further comprising a transmit module, said transmit module transmitting said expanded system configuration file to a media service provider upon request, wherein said transmission is wireless.

11. The set top box according to claim 9, further comprising a transmit module storing said expanded system configuration file.

12. A streaming media service, comprising:
a retrieve user profile module, said retrieve user profile module determining if said streaming media service has a user profile of 5 user preferences available;
said retrieve user profile module retrieving said user profile if said user profile is available;
a retrieve system configuration module, said retrieve system configuration module determining if said recommendation engine said streaming media service has an expanded system configuration file of components and properties of a rendering device available;
said retrieve system configuration module retrieving said expanded system configuration file, if said expanded system configuration file is available;
an identify media asset module, said identify media asset module identifying media assets that may be of interest to a user based on said user profile and said expanded system configuration file, said identify media asset module in communication with said retrieve system configuration module;
a retrieve media metadata module, said retrieve media metadata module retrieving media metadata of multiple versions of said identified media assets, said retrieve media metadata module in communication with said identify media assets module;
a select module, said select module selecting a particular version of a particular identified media asset from among the identified media assets using said media metadata to recommend to said user; and
a recommend particular version of media asset module, said recommend particular version of media asset module forwarding an indication of said selected particular version of said particular media asset to a set top box for said user, said recommend particular version of media asset module in communication with said select module.

13. The streaming media service according to claim 12, wherein said select module further retrieves aggregate scores of each media asset of said identified media assets, calculates a difference between each aggregate score of each media asset of said identified media assets and an aggregate score in said expanded system configuration file, calculates an absolute value of said difference and sorts said media asset responsive to said absolute value of said difference.

14. The streaming media service according to claim 13, wherein said aggregate scores of each media asset is based on properties of said media asset.

15. The streaming media service according to claim 12, wherein said 10 recommend particular version of media asset module further offers said user less expensive alternatives to said selected particular media asset if said selected particular media asset appears to be for a child, accepts said user's selection of said particular media asset and forwards said user's selection of said particular version of said particular media asset.

16. The set top box according to claim 10, wherein said transmission is wireless.

17. The streaming media service according to claim 12, wherein said forwarding is wireless.
